(19) United States
(12) Patent Application Publication
(10) Pub. No.: US 2023/0186791 A1
(43) Pub. Date: Jun. 15, 2023

(54) REAL SCALE LANDSLIDE SIMULATOR FOR EARTHQUAKE REPRODUCTION

(71) Applicant: NATIONAL DISASTER MANAGEMENT RESEARCH INSTITUTE, Ulsan (KR)

(72) Inventors: Min Su JUNG, Ulsan (KR); Jae Wook SEOK, Ulsan (KR); Hyang Seon JEONG, Ulsan (KR); Sun Gyu CHOI, Ulsan (KR); Hyo Sung SONG, Ulsan (KR)

(21) Appl. No.: 18/075,566

(22) Filed: Dec. 6, 2022

(30) Foreign Application Priority Data
Dec. 9, 2021 (KR) 10-2021-0175487

(51) Int. Cl. G09B 23/40

(52) U.S. Cl. CPC G09B 23/40

(57) ABSTRACT

Disclosed is a real-scale landslide simulator for earthquake reproduction comprising: a base; a tower provided in one end of the base; a multi-stage simulation soil box provided movably in the vertical direction along the tower and filled with soil, which is subjected to compaction; a movable bogie provided movably in the horizontal direction on the upper surface of the base while supporting the other side of the multi-stage simulation soil box; a vertical reciprocator that reciprocates the multi-stage simulation soil box in the vertical direction; and a horizontal reciprocator that reciprocates the movable bogie in the horizontal direction. It is possible to reproduce liquefaction and shear strength reduction caused by an earthquake and analyze a real-scale landslide mechanism caused by an earthquake by repeatedly providing vertical and horizontal vibrations to the soil and forming a groundwater level using the groundwater simulation device.

### CROSS-REFERENCE TO RELATED APPLICATIONS

This application claims the benefit of the Korean Patent Application No. 10-2021-0175487 filed on Dec. 9, 2021, which is hereby incorporated by reference as if fully set forth herein.

### TECHNICAL FIELD

The present invention relates to a real-scale landslide simulator for earthquake reproduction, and more particularly, to a real-scale landslide simulator capable of reproducing vibrations, liquefaction, and shear strength reduction caused by an earthquake by modeling a real-scale slope, forming a groundwater level, and repeatedly generating vibrations in the vertical and horizontal directions.

### BACKGROUND

South Korea belongs to an active seismic zone geologically, and small earthquakes occur dozens of times a year.

In Japan neighboring to South Korea, numerous earthquakes occur, and among them, some strong earthquakes cause a large number of human casualties and serious property damage.

Accordingly, Japanese people have been preparing for an earthquake by applying seismic design technology in building construction, building an early warning system, and consistently educating and practicing people how to act in the event of an earthquake.

Meanwhile, in South Korea, most of the earthquakes were weak, and there was no earthquake that could cause serious damage to life or property. Therefore, it is true that countermeasures against earthquakes were neglected and were not concerned too much.

However, in recent years, frequency of earthquakes has been increasing in South Korea as well, and earthquakes of magnitudes 5.1 and 5.8 occurred in Gyeong-ju city in 2016. Moreover, in Po-hang city in 2017, an earthquake of a magnitude of 5.4 occurred, causing human life and property damage. Therefore, it was confirmed that South Korea is not a safe zone for earthquakes any more.

In particular, in South Korea, the risk of landslide exists due to the geographical characteristics of many mountainous areas and the climatic characteristics where about ⅔ of the average annual rainfall is concentrated at one season.

Accordingly, in order to understand landslides caused by earthquakes, it is necessary to analyze and understand the landslide mechanism using a real-scale simulator. However, such a research environment has not been established yet.

### Citation List

[Patent Document 1] Korea Patent Registration No. 10-1820904

### SUMMARY

### Problems to Be Solved by the Invention

In order to address the problems of the prior art, the present invention provides a real-scale landslide simulator for earthquake reproduction, capable of analyzing a landslide mechanism caused by an earthquake by repeatedly generating vertical and horizontal vibrations on a slope built on a real scale to reproduce a landslide caused by an earthquake on a real scale.

### Means for Solving the Problems

According to the present invention, there is provided a real-scale landslide simulator for earthquake reproduction, comprising: a base; a tower provided in one end of the base; a multi-stage simulation soil box provided movably in the vertical direction along the tower and filled with soil, which is subjected to compaction; a movable bogie provided movably in the horizontal direction on the upper surface of the base while supporting the other side of the multi-stage simulation soil box; a vertical reciprocator that reciprocates the multi-stage simulation soil box in the vertical direction; and a horizontal reciprocator that reciprocates the movable bogie in the horizontal direction.

In addition, the tower may have a rail extending in the vertical direction, and a slider that moves along the rail in the vertical direction may be provided in one side of the multi-stage simulation soil box.

In addition, the multi-stage simulation soil box may include a first soil box having an elevation soil box provided with the slider to allow vertical movement and an inclination soil box having one end obliquely connected to the other end of the elevation soil box, a second soil box having one end pivotably connected to the other end of the inclination soil box, and a third soil box having one end pivotably connected to the other end of the second soil box.

In addition, the vertical reciprocator may include a first hydraulic cylinder provided in the base to reciprocate the elevation soil box in the vertical direction, and a second hydraulic cylinder provided in the movable bogie to reciprocate the second and third soil boxes in the vertical direction.

In addition, the horizontal reciprocator may include a hydraulic cylinder.

In addition, long holes elongated in the horizontal direction are provided at overlapping portions between the other end of the inclination soil box of the first soil box and one end of the second soil box and overlapping portions between the other end of the second soil box and one end of the third soil box, and connection pins are inserted into the long holes so as to be movable in the horizontal direction along the long holes.

The real-scale landslide simulator for earthquake reproduction may further comprise a groundwater simulation device configured to inject water into the soil compacted in the inclination soil box, the second soil box, and the third soil box from the bottoms of the inclination soil box of the first soil box, the second soil box, and the third soil box.

### Advantageous Effects

Using the real-scale landslide simulator for earthquake reproduction configured as described above, it is possible to analyze a real-scale landslide mechanism caused by an earthquake by repeatedly providing vertical and horizontal vibrations to the soil compacted in the multi-stage simulation soil box obliquely installed and reproducing a groundwater level.

In addition, it is possible to reproduce liquefaction and shear strength reduction caused by an earthquake and analyze a real-scale landslide mechanism caused by an earthquake by using the groundwater simulation device that injects water into the soil from the bottom.

### BRIEF DESCRIPTION OF THE DRAWINGS

FIGS. 1 and 2 are perspective views illustrating a real-scale landslide simulator for earthquake reproduction according to the present invention.

FIGS. 3 and 4 are front views illustrating the real-scale landslide simulator for earthquake reproduction according to the present invention.

FIG. 5 is a schematic diagram illustrating a state that soil is filled in the real-scale landslide simulator for earthquake reproduction according to the present invention.

### DETAILED DESCRIPTION

Hereinafter, a real-scale landslide simulator for earthquake reproduction according to an embodiment of the present invention will be described in details with reference to the accompanying drawings.

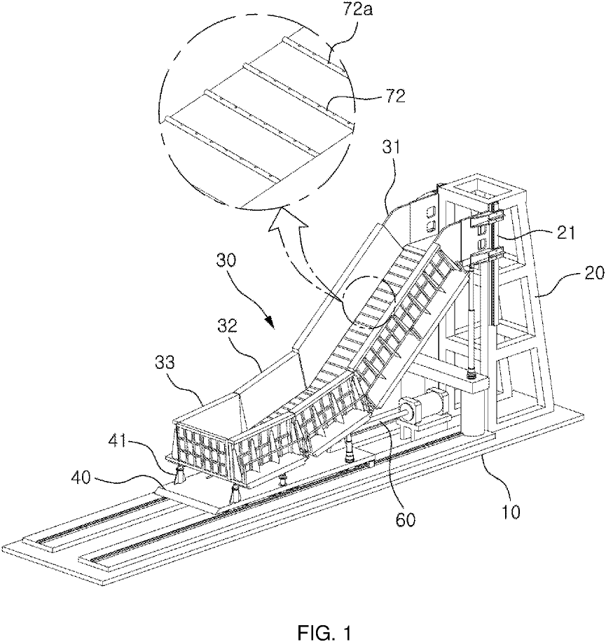

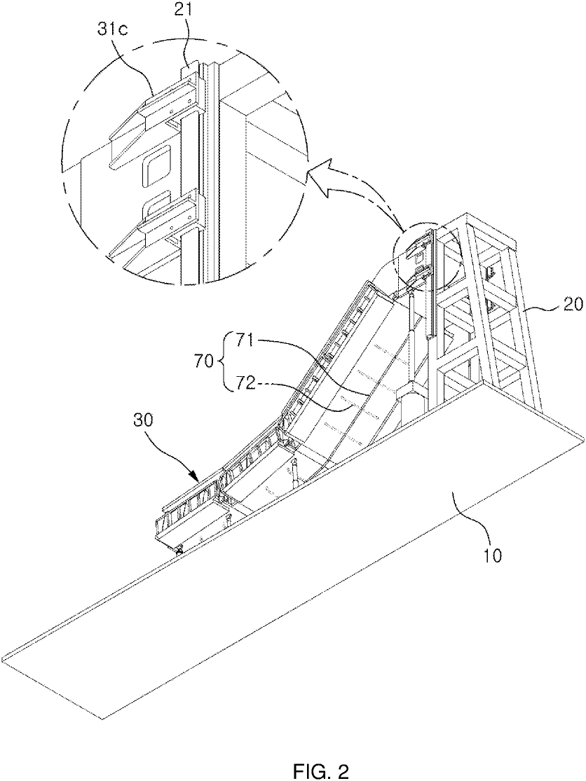

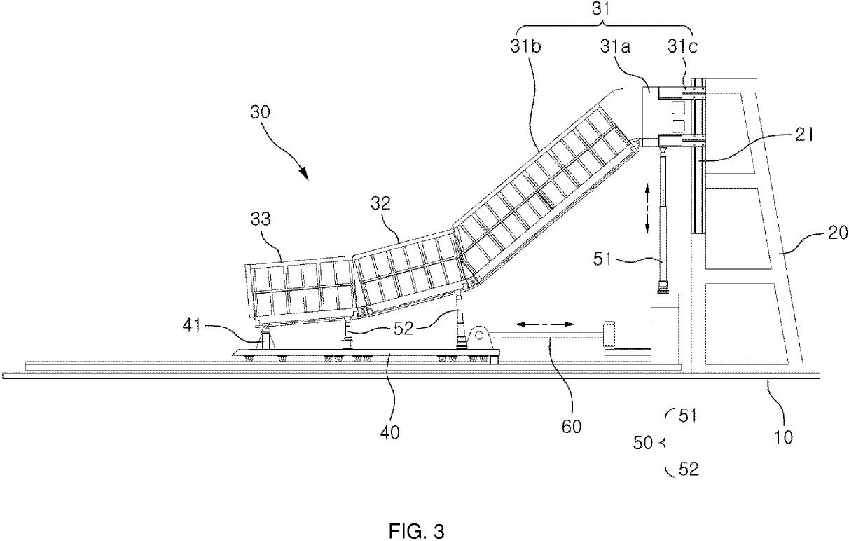

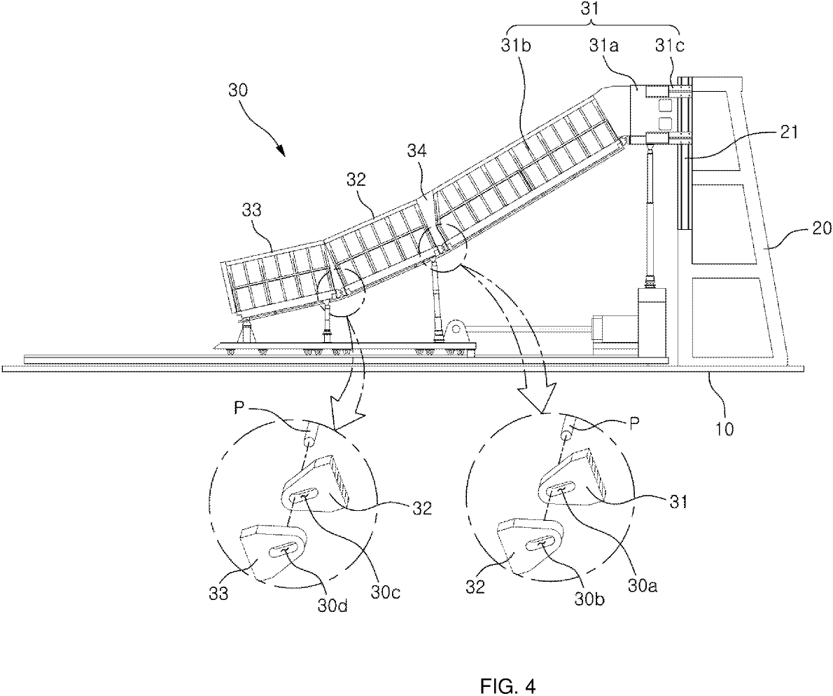

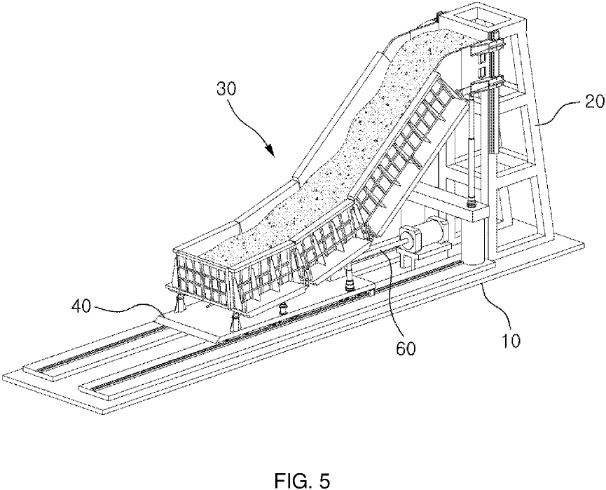

FIGS. 1 and 2 are perspective views illustrating a real-scale landslide simulator for earthquake reproduction according to the present invention. FIGS. 3 and 4 are front views illustrating the real-scale landslide simulator for earthquake reproduction according to the present invention. FIG. 5 is a schematic diagram illustrating a state that soil is filled in the real-scale landslide simulator for earthquake reproduction according to the present invention.

The real-scale landslide simulator for earthquake reproduction according to the present invention comprises a base 10, a tower 20 provided in one end of the base 10, a multi-stage simulation soil box 30 provided movably in the vertical direction along the tower 20, a movable bogie 40 that supports the other side of the multi-stage simulation soil box 30, a vertical reciprocator 50 that reciprocates the multi-stage simulation soil box 30 in the vertical direction, a horizontal reciprocator 60 that reciprocates the movable bogie 40 in the horizontal direction, and a groundwater simulation device 70 provided in the multi-stage simulation soil box 30 for supplying water to the soil from the bottom.

The base 10 is fabricated by combining a plurality of iron beams or frames, and is installed on the floor. The base 10 has a rail 11 installed on the upper surface in the longitudinal direction.

The tower 20 is a vertical structure made by combining iron beams or frames, and serves to support one end of the multi-stage simulation soil box 30 and allow one end of the multi-stage simulation soil box 30 to move up and down.

In other words, the tower 20 has a rail 21 installed to extend in the vertical direction and a slider 31c connected to one side of the multi-stage simulation soil box 30 and vertically movable along the rail 21.

The multi-stage simulation soil box 30 is filled with soil, which is subjected to compaction, and one side of the multi-stage simulation soil box 30 is connected to the tower 20 so as to provide inclination.

The multi-stage simulation soil box 30 has a first soil box 31, a second soil box 32 pivotably connected to the first soil box 31, and a third soil box 33 pivotably connected to the second soil box 32.

The first soil box 31 has an elevation soil box 31a and an inclination soil box 31b obliquely connected to the elevation soil box 31a.

The elevation soil box 31a is provided with a slider 31c that moves vertically along the rail 21 extending in the vertical direction on the tower 20.

One end of the inclination soil box 31b is obliquely connected to the other end of the elevation soil box 31a.

One end of the second soil box 32 is pivotably connected to the other end of the inclination soil box 31b.

Specifically, one end of the second soil box 32 and the other end of the inclination soil box 31b overlap each other, and long holes 30b and 30a elongated in the horizontal direction are respectively formed in the overlapping portions. A connection pin P is inserted into the long hole 30a of the inclination soil box 31b and the long hole 30b of the second soil box 32 so as to be movable along the long holes 30a and 30b in the horizontal direction. That is, the connection pin P has a diameter smaller than each of the horizontal inner diameters of the long holes 30a and 30b formed in the inclination soil box 31b and the second soil box 32, so as to be movable within the long holes 30a and 30b in the horizontal direction.

One end of the third soil box 33 is pivotably connected to the other end of the second soil box 32.

Specifically, one end of the third soil box 33 and the other end of the second soil box 32 overlap each other, and long holes 30d and 30c elongated in the horizontal direction are respectively formed in the overlapping portions. A connection pin P is inserted into the long hole 30c formed at the other end of the second soil box 32 and the long hole 30d of the third soil box 33 so as to be movable along the long holes 30c and 30d in the horizontal direction. That is, the connection pin P has a diameter smaller than each of the horizontal inner diameters of the long holes 30d and 30c formed at the other end of the third soil boxes 33 and the other end of the second soil box 32, so as to be movable within the long holes 30d and 30c in the horizontal direction.

By inserting the connection pins P having small diameters into the long holes formed in the first, second, and third soil boxes 31, 32, and 33 as described above, each of the first, second, and third soil boxes 31, 32, and 33 and their components can actively respond without any damage when the connection angles between the soil boxes 31, 32, and 33 are changed.

Meanwhile, blocking panels 34 are installed between the elevation soil box 31a of the first soil box 31 and the second soil box 32 and between the second soil box 32 and the third soil box 33, so that the soil is prevented from flowing out therethrough when the connection angle between the elevation soil box 31a and the second soil box 32 is changed, or the connection angle between the second soil box 32 and the third soil box 33 is changed.

The movable bogie 40 is installed to be movable in the horizontal direction on the upper surface of the base 10 while supporting the second and third soil boxes 32. That is, the movable bogie 40 moves on the upper surface of the base 10 along the rail 11 provided on the upper surface of the base 10.

A support member 41 for supporting the third soil box 33 is installed on the upper surface of the other end of the movable bogie 40.

The vertical reciprocator 50 has one first hydraulic cylinder 51 and two second hydraulic cylinders 52.

The first hydraulic cylinder 51 is installed on the upper surface of the base 10 to reciprocate the elevation soil box 31a in the vertical direction. That is, when the rod of the first hydraulic cylinder 51 advances, the elevation soil box 31a moves upward along the tower 20. When the rod of the first hydraulic cylinder 51 retreats, the elevation soil box 31a moves downward along the tower 20. As a result, when the elevation soil box 31a moves up and down, the inclination soil box 31b connected to the elevation soil box 31a also moves up and down.

The second hydraulic cylinder 52 is installed in the movable bogie 40. For example, one of the second hydraulic cylinders 52 is installed in the lower side of the second soil box 32, and the other second hydraulic cylinder 52 is installed in the lower side of the third soil box 33, so as to reciprocate the second and third soil boxes 32 and 33 in the vertical direction.

Meanwhile, the rods of the first and second hydraulic cylinders 51 and 52 repeatedly advances and retreats in the vertical direction by about 10 to 20 cm per second, so as to provide equalized vibration to the multi-stage simulation soil box 30 in the vertical direction. As a result, a longitudinal wave (P-wave) is applied to the soil compacted in the multi-stage simulation soil box 30.

The horizontal reciprocator 60 reciprocates the movable bogie 40 in the horizontal direction so as to apply a transverse wave (S-wave) to the soil compacted in the multi-stage simulation soil box 30. The horizontal reciprocator 60 includes a hydraulic cylinder.

The groundwater simulation device 70 is configured to inject water into the soil compacted in the inclination soil box 31b, the second soil box 32, and the third soil box 33 from the bottoms of the inclination soil box 31b of the first soil box 31, the second soil box 32, and the third soil box 33.

Specifically, the groundwater simulation device 70 is provided to reproduce liquefaction and shear strength reduction caused by an earthquake, and may include a tube having a plurality of water discharge holes 72a formed at regular intervals.

More specifically, the groundwater simulation device 70 has a pipe 71 provided on the bottom of the base 10 and supplied with water from the outside and tubes 72 provided on the upper surfaces of the inclination soil box 31b, the second soil box 32, and a third soil box 33 and supplied with water from the pipe 71.

Each of the tubes 72 has water discharge holes formed at regular intervals to supply water from the pipe 71 into a gap between the soil and the bottom surface of the multi-stage simulation soil box 30. As a result, it possible to reproduce liquefaction and shear strength reduction caused by an earthquake.

Reference Signs List

| | |
|---|---|
| 10: | base |
| 11: | rail |
| 20: | tower |
| 21: | rail |
| 30: | multi-stage simulation soil box |
| 30a, 30b, 30c, 30d: | long hole |
| 31: | first soil box |
| 31a: | elevation soil box |
| 31b: | inclination soil box |
| 31c: | slider |
| 32: | second soil box |
| 33: | third soil box |
| 34: | blocking panel |
| 40: | movable bogie |
| 41: | support member |
| 50: | vertical reciprocator |
| 51: | first hydraulic cylinder |
| 52: | second hydraulic cylinder |
| 60: | horizontal reciprocator |
| 70: | groundwater simulation device |
| 71: | pipe |
| 72: | tube |
| 72a: | water discharge hole |
| P: | connection pin |

What is claimed is:

1. A real-scale landslide simulator for earthquake reproduction, comprising:
a base;
a tower provided in one end of the base;
a multi-stage simulation soil box provided movably in the vertical direction along the tower and filled with soil, which is subjected to compaction;
a movable bogie provided movably in the horizontal direction on the upper surface of the base while supporting the other side of the multi-stage simulation soil box;
a vertical reciprocator that reciprocates the multi-stage simulation soil box in the vertical direction; and
a horizontal reciprocator that reciprocates the movable bogie in the horizontal direction.

2. The real-scale landslide simulator for earthquake reproduction according to claim 1, wherein the tower has a rail extending in the vertical direction, and
a slider that moves along the rail in the vertical direction is provided in one side of the multi-stage simulation soil box.

3. The real-scale landslide simulator for earthquake reproduction according to claim 2, wherein the multi-stage simulation soil box includes
a first soil box having an elevation soil box provided with the slider to allow vertical movement and an inclination soil box having one end obliquely connected to the other end of the elevation soil box,
a second soil box having one end pivotably connected to the other end of the inclination soil box, and
a third soil box having one end pivotably connected to the other end of the second soil box.

4. The real-scale landslide simulator for earthquake reproduction according to claim 3, wherein the vertical reciprocator includes
a first hydraulic cylinder provided in the base to reciprocate the elevation soil box in the vertical direction, and
a second hydraulic cylinder provided in the movable bogie to reciprocate the second and third soil boxes in the vertical direction.

5. The real-scale landslide simulator for earthquake reproduction according to claim 3, wherein the horizontal reciprocator includes a hydraulic cylinder.

6. The real-scale landslide simulator for earthquake reproduction according to claim 3, wherein long holes elongated in the horizontal direction are provided at overlapping portions between the other end of the inclination soil box of the first soil box and one end of the second soil box and overlapping portions between the other end of the second soil box and one end of the third soil box, and
connection pins are inserted into the long holes so as to be movable in the horizontal direction along the long holes.

7. The real-scale landslide simulator for earthquake reproduction according to claim 3, further comprising a groundwater simulation device configured to inject water into the soil compacted in the inclination soil box, the second soil box, and the third soil box from the bottoms of the inclination soil box of the first soil box, the second soil box, and the third soil box.
